(19) United States
(12) Patent Application Publication
(10) Pub. No.: US 2007/0113873 A1
(43) Pub. Date: May 24, 2007

(54) METHOD FOR CLEANING OPTICAL FILMS

(76) Inventor: Kun-Hsuan Yang, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/381,359

(22) Filed: May 3, 2006

(30) Foreign Application Priority Data
Nov. 24, 2005 (TW) 094141275

(51) Int. Cl. B08B 3/00

(52) U.S. Cl. 134/29; 134/26

(57) ABSTRACT

A method of cleaning used to clean alkalized optical films has a first rinsing process by which a base liquid on the optical film is rinsed, a second rinsing process by which remaining alkaline solution on the optical film is rinsed, and a drying process by which water remaining on the optical film is removed.

### BACKGROUND OF THE INVENTION

1. Field of the Invention

The invention relates to a method for cleaning optical films, and more particularly, to a method for cleaning alkalized optical films.

2. Description of the Prior Art

A polarizer is an essential element used to transform unpolarized light into polarized light in a liquid crystal display (LCD). An LCD can control light flux to display different color signals by utilizing polarized light, the rotational character of liquid crystal molecules, and a color filter.

Please refer to FIG. 1, which is a schematic cross-sectional diagram demonstrating a polarizer. A polarizer 10 typically includes a protection film 100 such as a polyethylene film, triacetyl cellulose (TAC) films 102 and 106, a polyvinyl alcohol (PVA) film 104, a thermal bonding film 108, and a release film 110. The TAC films 102 and 106 are used to support and protect the PVA film 104. Furthermore, the polarizer can be coated with a wide-view film or a brightness enhancing film. The TAC films 102 and 106 can be cross-linked with liquid crystal molecules on one of their surfaces to form a super wide-view TAC (SWV TAC) or an anti-glare TAC (AG TAC) for particular purposes.

Generally, TAC films are pre-treated with an alkaline solution before coating to the PVA film. After alkalizing, TAC films need to undergo a cleaning process to remove the remaining alkaline solution. Then, TAC films can be stored. Please refer to FIG. 2, which is a schematic drawing of a conventional alkalization and cleaning processes for TAC films. As shown in FIG. 2, a TAC film 20 is loaded into an unwinding machine 200 and driven forward by a rewinding machine 212. The TAC film 20 is alkalized by an alkaline solution such as potassium hydroxide (KOH) or sodium hydroxide (NaOH) in an alkalization tank 202. Then a rinsing process is performed in a first rinsing tank 204 to remove the alkaline solution from the surface of the TAC film 20. Another rinsing process is then performed in a second rinsing tank 206 to further remove the remaining alkaline solution from the surface of the TAC film 20. In addition, sulfuric acid can be added into the second rinsing tank 206 to neutralize the remaining alkalinity, and therefore the second rising tank 206 is called a neutralization tank. Thereafter, the TAC film 20 undergoes another rinsing process in a third rinsing tank 208 to clean the surface of the TAC film 20 with pure water. Finally, the water on the surface of the TAC film 20 is removed by an oven 210 and the TAC film 20 is stored up by the rewinding machine 212 for subsequent processes.

However, there are some unexpected problems that often happen in the conventional pre-treatment of TAC films, such as white spots resulting from sodium acetate formed in alkalization or from dried alkaline solution or water marks left after the oven when the temperature is not high enough.

Furthermore, please refer to FIG. 3, which is a schematic cross-sectional diagram demonstrating a SWV TAC film. As shown in FIG. 3, a SWV TAC film 30 is made by coating the TAC film 302 with an alignment layer 304 and cross-linking with a liquid crystal molecule layer 306 on a surface of the TAC film 302. Because the alignment layer 304 is easily damaged by the alkaline solution in the alkalization process, the liquid crystal molecule layer 306 must entirely cover the alignment layer 304. In addition, the margin of the liquid crystal molecule layer 304 is patterned for storing the SWV TAC film 30. Due to poor adhesion between the TAC film 302 and the pattern section 308 of the liquid crystal molecule layer 306, the liquid crystal molecules in the pattern section 308 are easily affected by temperature or pressure from the roll of the unwinding machine and are apt to peel off under certain conditions. Therefore the SWV TAC film 30 is not only susceptible to the aforementioned white spot or water mark problems, but also to a problem caused by liquid crystal molecules peeling from the surface of the liquid crystal molecule layer 306.

To solve the aforementioned problem, there are many methods provided by the prior art, such as raising the temperature of the neutralization tank or increasing the concentration of sulfuric acid to reduce the formation of the white spots, or raising the temperatures in each rinsing tank to over 35° C. to improve the cleaning effect. However, if the aforementioned solutions are applied to a SWV TAC film, they increase the amount of liquid crystal molecules that peel from the pattern section of the SWV TAC film. Furthermore, in order to prevent TAC film from forming water marks, the temperature of the oven is raised to over 95° C. in the prior art, but this high temperature can make the TAC film fragile.

Therefore the prior art provides another method to prevent the abovementioned problems, which is to attach a protecting film on the surface of the TAC film. However, this method is more complicated due to the added processes for attaching and removing the protecting film. In addition, the protecting film itself is a consumable material, and therefore the cost is increased.

### SUMMARY OF THE INVENTION

It is one object of the present invention is to provide a method for cleaning optical films. The provided method is for cleaning an alkalized optical film and preventing such film from forming white spots and water marks. Furthermore, the provided method simplifies the cleaning processes.

According to the claimed invention, a method for cleaning an optical film after alkalization is provided. The method comprises performing a first rinsing process to clean the optical film, performing a second rinsing process comprising at least an organic solution to further clean the optical film, and performing a drying process to remove water remaining on optical film.

According to the method provided by the claimed invention, each rinsing process can be performed at room temperature. In addition, additional process for attaching and removing the protecting layers on each side of the optical film is economized, and therefore the processes are simplified and cost is decreased.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional diagram illustrating a polarizer.

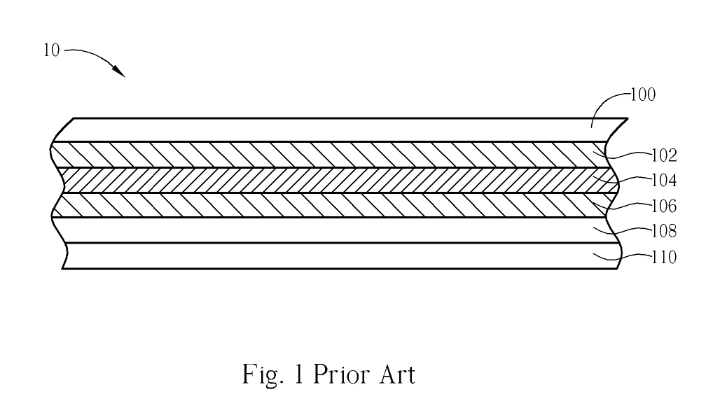

FIG. 2 is a schematic drawing illustrating a conventional alkalization and cleaning processes for TAC films.

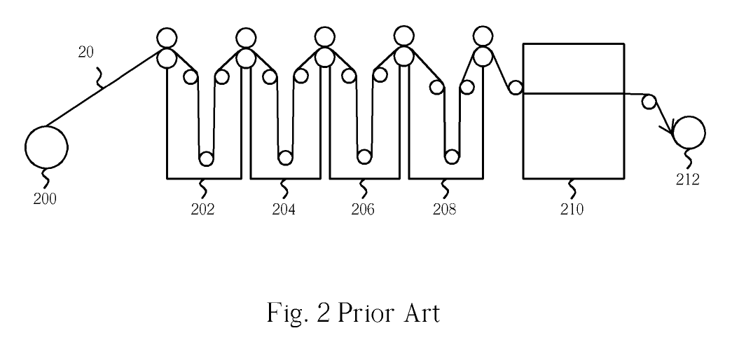

FIG. 3 is a schematic cross-sectional diagram illustrating a SWV TAC film.

FIG. 4 is a schematic drawing illustrating a preferred embodiment provided by the present invention.

### DETAILED DESCRIPTION

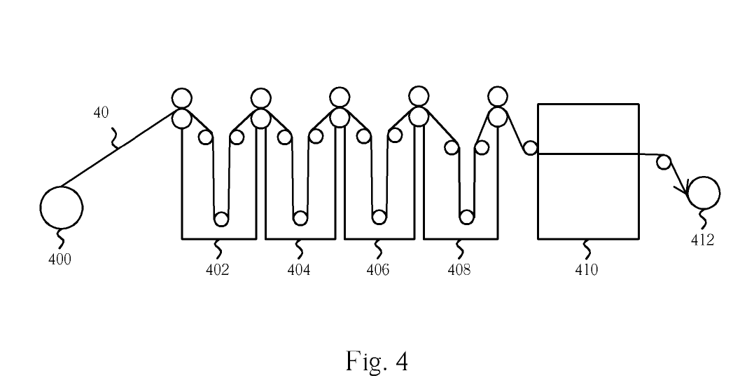

Please refer to FIG. 4, which is a schematic drawing illustrating a preferred embodiment provided by the present invention. The method for cleaning an optical film provided by the present invention can be applied to every kind of optical film such as surface-untreated TAC film, SWV TAC on which liquid crystal molecules are attached, wide-view TAC, brightness enhanced TAC, or anti-glare TAC.

As shown in FIG. 4, an optical film 40 is loaded into an unwinding machine 400 and is driven forward by a rewinding machine 412. The optical film 400 is first alkalized in an alkalization tank 402. The alkalization tank 402 has an alkaline solution, such as potassium hydroxide solution (KOH) or sodium hydroxide (NaOH) having a concentration in a range of 5%-10%. A temperature of the alkalization tank 402 is about 45° C.-55° C. Then, a first rinsing process is performed in a first rinsing tank 404 which contains pure water. Because the first rinsing tank 402 is used to rinse away the alkaline solution remaining on the optical film 40, the amount of time spent in the first rinsing tank 402 is adjustable depending on the requirement. In addition, for completely rinsing sodium acetate formed in the alkalization process and the remaining alkaline solution and preventing the optical film 40 from shrinking and expanding, the temperature of the first rinsing process is slightly lower than the temperature of the alkalization process and is, for example, 30° C.-40° C.

Next, to remove white spots formed by sodium acetate more effectively, the method for cleaning an optical film provided by the present invention further comprises a neutralization process. The neutralization process is performed in a neutralization tank 406 which contains at least an acidic solution such as sulfuric acid. The concentration of the sulfuric acid is less than 4%.

Thereafter, a second rinsing process used to further clean the optical film 40 is performed in a second rinsing tank 408 which contains at least an organic solution. The organic solution is a volatile organic solution comprising alcohol, ketone, or ester such as methanol, ethanol, propanol, isopropanol, acetone, methyl ethyl ketone, or ethyl acetate, or preferably isopropanol. The concentration of the organic solution is in a range of 1%-20% and preferably 5%-6%.

The cleaning effect of the method provided by the present invention is achieved by the concept of “like dissolves like”, with polar material attracting polar material and non-polar material attracting non-polar material. The organic solution added in the second rinsing process can dissolve in water and is not dangerous to the TAC film 40. Furthermore, when the organic solution is applied in cleaning the SWV TAC film, peeled liquid crystal molecules are prevented from attaching to the surface of the SWV TAC film.

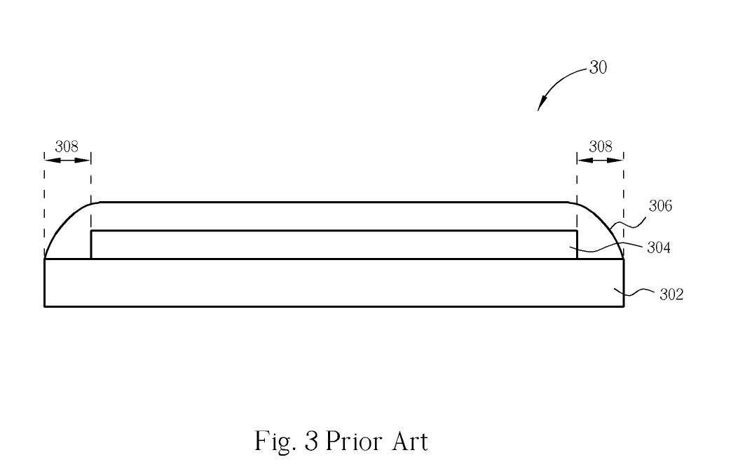

Please refer to FIG. 3 again. As mentioned, the liquid crystal molecules of the liquid crystal molecule layer 306 cross-linked on a surface of the SWV TAC film 30 are easily peeled during the alkalization process and the rinsing processes. Such peeled liquid crystal molecules often attach themselves to the surface of the liquid crystal layer 306 and not on the other surface of the TAC film 302 which has not been cross-linked with liquid crystal molecules. When the organic solution added in the second rinsing process is applied to rinse the SWV TAC film 30, it decreases the contact angle of the liquid crystal molecule layer 306 from 90 degrees to lower than 35 degrees. Due to the decrease of the contact angle of the liquid crystal molecule layer 306, the surface of the liquid crystal molecule layer 306 can be wetted and separated from the peeled liquid crystal molecules by the organic solution. Therefore the peeled liquid crystal molecules are effectively prevented from attaching to the SWV TAC film 30. In addition, because the organic solution comprises a hydrophobic base such as hydrocarbon radicals which have stronger van der Waal force with the peeled liquid crystal molecules, and a hydrophilic base such as hydroxyl radicals, which are easily dissolved in water due to the hydrogen bond formed in between, the organic solution therefore functions as a detergent: it readily removes the peeled liquid crystal molecules and itself is easily removed by water.

Please refer to Table 1 which illustrates a comparison between the method provided by the present invention and the prior art:

TABLE 1
Comparison of the cleaning effects between the method
provided by the present invention and the prior art

| | Organic solution/ | Amount of attached |
|---|---|---|
| | concentration | liquid crystal molecules |
| Prior art | none | 4-6 |
| Embodiment 1 | Methanol/1-20% | 2-3 |
| Embodiment 2 | Ethanol/1-20% | 1-3 |
| Embodiment 3 | Propanol/1-20% | 1-3 |
| Embodiment 4 | Isopropanol/1-20% | 0-1 |
| Embodiment 5 | Acetone/1-20% | 1-3 |
| Embodiment 6 | Methyl ethyl ketone/1-20% | 1-3 |
| Embodiment 7 | Ethyl acetate/1-20% | 0-3 |

According to the observed data shown in Table 1, the method of cleaning an optical film provided by the present invention effectively solves the problem of the prior art. It is noteworthy that because the added organic solution improves the cleanliness and decreases the attachment of the liquid crystal molecules, the temperatures of the neutralization tank 406 and the second rinsing tank 408 are not raised, but remain at room temperature. Therefore the application of the organic solution on the SWV TAC film can further decrease the amount of peeled liquid crystal molecules in the pattern section. Furthermore, the addition of organic solution is not limited in the second rinsing process, but can be selectively added to the first rinsing process or the neutralization process depending on the requirements or considerations for any special products.

Please refer to FIG. 4. The present invention further provides a drying process. In the drying process, the optical film 40 is driven to pass through an oven 410. Because the organic solution comprises alcohol, ketone, or acetate, which are volatile, the boiling point is reduced. Therefore the temperature of the oven 410 is set at between 70° C.-80° C. to dry out the water on the surface of the optical film 40. Thus, the fragility problem of the optical film 40 caused by the prior art high temperature in the oven 410 is prevented. Finally, the optical film 40 is stored by the rewinding machine 412 for following processes.

As mentioned above, the method provided by the present invention is to add organic solution in the second rinsing process to rinse away white spots on the surface of the optical film after an alkalization process. Furthermore, according to the method provided by the present invention, the neutralization process and the second rinsing process are performed at room temperature, which can further reduce the amount of peeled liquid crystal molecules. In addition, the temperature of the oven in the drying process is deceased to 70° C., which can prevent the fragility problem. Therefore the method provided by the present invention not only effectively removes white spots and peeled liquid crystal molecules from the optical film, but also simplifies the cleaning processes for an optical film.

Those skilled in the art will readily observe that numerous modifications and alterations of the device and method may be made while retaining the teachings of the invention. Accordingly, the above disclosure should be construed as limited only by the metes and bounds of the appended claims.

1. A method for cleaning a tri-acetyl cellulose (TAC) film after alkalization comprising:
performing a first rinsing process comprising at least a first organic solution to clean the optical TAC film;
performing a second rinsing process comprising at least a second organic solution to further clean the optical TAC film; and
performing a drying process to remove water remaining on the optical TAC film.

2. (canceled)

3. The method of claim 1, wherein the alkalization is performed in an alkalization tank, and the alkalization tank has a potassium hydroxide (KOH) solution or a sodium hydroxide (NaOH) solution within.

4. The method of claim 3, wherein a concentration of the potassium hydroxide solution or the sodium hydroxide solution is in a range of 5%-10% by weight.

5. The method of claim 1, wherein the first rinsing process is performed in at least a first rinsing tank, and the first rinsing tank has pure water within.

6. (canceled)

7. The method of claim 1, wherein the first organic solution has a concentration in a range of about 1%-20% by weight.

8. The method of claim 7, wherein the concentration of the first organic solution is in a range of about 5%-6% by weight.

9. The method of claim 1, wherein the first organic solution is a volatile organic solution comprising alcohols, ketone, or ester.

10. The method of claim 9, wherein the first organic solution comprises methanol, ethanol, propanol, isopropanol, acetone, methyl ethyl ketone, or ethyl acetate.

11. The method of claim 1, further comprises a neutralization process performed after the first rinsing process.

12. The method of claim 11, wherein the neutralization process is performed in a neutralization tank, and the neutralization tank has at least an acidic solution within.

13. The method of claim 12, wherein the acidic solution comprises sulfuric acid (H₂SO₄).

14. The method of claim 13, wherein the concentration of the sulfuric acid is less than 4% by weight.

15. The method of claim 12, wherein the neutralization tank further has at least an organic solution.

16. The method of claim 15, wherein the organic solution has a concentration in a range of about 1%-20% by weight.

17. The method of claim 16, wherein the concentration of the organic solution is in a range of about 5%-6% by weight.

18. The method of claim 15, wherein the organic solution is a volatile organic solution comprising alcohols, ketone, or ester.

19. The method of claim 18, wherein the organic solution comprises methanol, ethanol, propanol, isopropanol, acetone, methyl ethyl ketone, or ethyl acetate.

20. The method of claim 11, wherein the neutralization process is performed at room temperature.

21. The method of claim 1, wherein the second rinsing process is performed in a second rinsing tank, and the second rinsing tank has pure water within.

22. The method of claim 1, wherein the second organic solution has a concentration in a range of about 1%-20% by weight.

23. The method of claim 22, wherein the concentration of the second organic solution is in a range of about 5%-6% by weight.

24. The method of claim 1, wherein the second organic solution is a volatile organic solution comprising alcohols, ketone, or ester.

25. The method of claim 24, wherein the second organic solution comprises methanol, ethanol, propanol, isopropanol, acetone, methyl ethyl ketone, or ethyl acetate.

26. The method of claim 1, wherein the second rinsing process is performed at room temperature.

27. The method of claim 1, wherein the drying process comprises using an oven to dry water remaining on the TAC film.
